(19) United States
(12) Patent Application Publication
(10) Pub. No.: US 2005/0212731 A1
(43) Pub. Date: Sep. 29, 2005

(54) Self-luminous display apparatus and method of driving the same

(75) Inventor: Shingo Kawashima, Kanagawa (JP)

Correspondence Address: FOLEY AND LARDNER;SUITE 500, 3000 K STREET NW, WASHINGTON, DC, 20007, US

(73) Assignee: NEC Electronics Corporation

(21) Appl. No.: 11/086,682

(22) Filed: Mar. 23, 2005

(30) Foreign Application Priority Data
Mar. 26, 2004 (JP) 2004-091998
Oct. 19, 2004 (JP) 2004-304525

(51) Int. Cl. G09G 3/30

(52) U.S. Cl. 345/76

(57) ABSTRACT

A self-luminous display apparatus, which is of a passive matrix type, includes a display panel having N (N is a natural number) scanning lines. The N scanning lines includes a first scanning line and a second scanning line which is driven next to the first scanning line. When a frame frequency is f [Hz], a distance between the first scanning line and the second scanning line is set to not less than 150/(Nf) times a length of a screen of the display panel along a scanning direction.

### BACKGROUND OF THE INVENTION

1. Field of the Invention The present invention relates to a self-luminous display apparatus. In particular, the present invention relates to a passive matrix type self-luminous display apparatus and a method of driving the same.

2. Description of the Related Art

A plasma display apparatus and an organic EL (Electro-Luminescence) display apparatus are known as a “self-luminous display apparatus”. A display panel of such a display apparatus has a plurality of pixels which are arranged in a matrix form. Also, a “passive matrix type (method)” and an “active matrix type (method)” are known as a method of driving the display apparatus. According to the passive matrix method, a row electrode and a column electrode are arranged to intersect with each other, and a pixel emits light by applying a voltage between a specified row electrode and a specified column electrode. According to the active matrix method, a switching device such as an a TFT (Thin Film Transistor) and the like is provided for each of the plurality of pixels and controls the light emission of each pixel. In the field of such an self-luminous display apparatus, a technique is desired which can prevent a flicker and hence improve display quality.

A display apparatus displays a video by sequentially displaying a large number of still pictures. The number of still pictures (frames) which are displayed per unit time is called a “frame frequency”. The large number of still pictures which are sequentially switched are visually recognized as a moving picture by humans. It is therefore necessary to drive the display apparatus by considering characteristics of vision of humans. The eye movement of humans is roughly classified into a “tracking movement” and a “rapid eye movement (saccade)”. The tracking movement is an eye movement for successively tracking a moving body, and it is known that an angular velocity of the tracking movement is up to 30°/sec. On the other hand, the saccade is an eye movement for changing a view point from a point of regard to another point of regard. It is known that an angular velocity of the saccade is approximately 600°/sec and reaches up to 700°/sec in the case of humans. It is also known that the minimum angle of resolution of human's eye is about 0.5 arc-minute.

Japanese Laid Open Patent Application (JP-P2003-140593A) discloses a method of displaying an image. According to the method, an image is displayed with a frame frequency which is substantially equal to a ratio between the minimum angle of resolution of human's eye and the maximum angular velocity of the “tracking movement”. For example, the frame frequency is set to 3.6 kHz. Or, an image is displayed with a frame frequency which is higher than a ratio between the minimum angle of resolution of human's eye and the maximum angular velocity of the “tracking movement”.

Japanese Laid Open Patent Application (JP-P2003-122303A) discloses a method of driving an active matrix type EL display apparatus. According to the method, a reverse bias is applied to an EL device when the EL device is not lighting. Also, in an EL device, a current flows for 1/N period of one frame, and a current does not flow for (N−1)/N period of the one frame. In other words, according to the conventional technique, an areawide displaying is performed over 1/N part of a display area at a certain instance. Here, the displaying is carried out such that luminance in the emitting area is substantially N times as high as a predetermined luminance. The other area, i.e. the (N−1)/N part of the display area is set to a non-lighting status.

### SUMMARY OF THE INVENTION

An object of the present invention is to provide a passive matrix type self-luminous display apparatus and a method of driving the same which can reduce the flicker.

Another object of the present invention is to provide a passive matrix type self-luminous display apparatus and a method of driving the same which can suppress the electric power consumption.

Still another object of the present invention is to provide a passive matrix type self-luminous display apparatus and a method of driving the same which can suppress the deterioration of light emitting devices.

In an aspect of the present invention, a self-luminous display apparatus, which is of a passive matrix type, includes a display panel having N (N is a natural number) scanning lines, and a controller for driving the N scanning lines sequentially. The controller preferably drives the N scanning lines by using an interlace scanning scheme. The N scanning lines includes a first scanning line, and a second scanning line which is driven next to the first scanning line. When a frame frequency is f [Hz], the controller sets a distance between the first scanning line and the second scanning line to not less than 150/(Nf) times a length of a screen of the display panel along a scanning direction.

In this case, an angular velocity of a motion of an emission line becomes larger than the angular velocity of the saccade. As a result, the flicker (flickering, flashing) peculiar to a passive matrix type self-luminous display apparatus is reduced. Moreover, it is not necessary to increase the frame frequency for the purpose of reducing the flicker. It is therefore possible to reduce the number of charging and discharging times for the parasitic capacitance included in a light emitting device (pixel), which can reduce the electric power consumption. Furthermore, it is possible to increase one emission period of the light emitting device. Thus, it is not necessary to make one light emitting device to emit with excess luminance. Therefore, the deterioration of the light emitting device can be suppressed.

In the self-luminous display apparatus according to the present invention, the above-mentioned N scanning lines further includes a third scanning line, and a fourth scanning line which is driven next to the third scanning line. The controller sets a distance between the third scanning line and the fourth scanning line to not less than 150/(Nf) times a length of the screen along the scanning direction. Also, the distance between the first scanning line and the second scanning line is different from the distance between the third scanning line and the fourth scanning line. It is preferable that a direction from the first scanning line to the second scanning line is opposite to a direction from the third scanning line to the fourth scanning line.

In another aspect of the present invention, a self-luminous display apparatus, which is of a passive matrix type, includes a display panel having N (N is a natural number) scanning lines, and a controller for driving the N scanning lines sequentially. The N scanning lines includes m (m is a natural number; m≧2) scanning line groups. Each of the m scanning line groups includes the k (k is a natural number) scanning lines. The controller drives the j-th (j is a natural number; 1≦j≦k) scanning line of the i-th (i is a natural number; 1≦i≦m) scanning line group in the (i+m(j−1))-th turn in one frame. When a frame frequency is f [Hz], the m is set to satisfy an equation: 2≦m≦Nf/150. For example, the m is set to 2, and the k is set to N/2.

In still another aspect of the present invention, a self-luminous display apparatus, which is of a passive matrix type, includes a display panel having N (N is a natural number) scanning lines, and a controller for driving the N scanning lines sequentially. The N scanning lines includes a first scanning line, a second scanning line which is driven next to the first scanning line, a third scanning line, and a fourth scanning line which is driven next to the third scanning line. The controller sets a distance between the first scanning line and the second scanning line different from a distance between the third scanning line and the fourth scanning line. It is preferable that a direction from the first scanning line to the second scanning line is opposite to a direction from the third scanning line to the fourth scanning line.

The saccade motion of an eyeball is classified into ballistic motions which can not be controlled during the motion. That is to say, it is not possible to adjust the saccade motion by the sensory feedback. Thus, the saccade motion can be considered to be a uniform motion. According to the above-mentioned self-luminous display apparatus, the angular velocity of the movement of an emission line varies. As a result, it is possible to reduce the probability that the eyeball consecutively moves in synchronization with the emission line. Thus, the flicker recognized by human brain can be further reduced. Moreover, the direction of the movement of the emission line is appropriately changed, which can further reduce the flicker.

In still another aspect of the present invention, a compact display apparatus includes a self-luminous display apparatus which is of a passive matrix type, and a lens of x magnifications provided for the self-luminous display apparatus. The self-luminous display includes a display panel having N (N is a natural number) scanning lines. The N scanning lines are preferably driven by using an interlace scanning scheme. The N scanning lines includes a first scanning line, and a second scanning line which is driven next to the first scanning line. When a frame frequency is f [Hz], a distance between the first scanning line and the second scanning line is set to not less than 150/(xNf) times a length of a screen of the display panel along a scanning direction.

In still another aspect of the present invention, a compact display apparatus includes a self-luminous display apparatus which is of a passive matrix type, and a lens of x magnifications provided for the self-luminous display apparatus. The self-luminous display includes a display panel having N (N is a natural number) scanning lines. The N scanning lines includes m (m is a natural number; m≧2) scanning line groups. Each of the m scanning line groups includes the k (k is a natural number) scanning lines. The j-th (j is a natural number; 1≦j≦k) scanning line of the i-th (i is a natural number; 1≦i≦m) scanning line group is driven in the (i+m(j−1))-th turn in one frame. Also, when a frame frequency is f [Hz], the m is set to satisfy an equation: 2≦m≦xNf/150.

In the self-luminous display apparatus mentioned above, the display panel may be an organic EL panel. The display panel may be a plasma display panel. The display panel may be a passive matrix type light emitting diode display panel.

In still another aspect of the present invention, a method of driving the self-luminous display apparatus includes: (a) driving a first scanning line of the N scanning lines; and (b) driving a second scanning line of the N scanning lines immediately after the (a) driving. When a frame frequency is f [Hz], a distance between the first scanning line and the second scanning line is set to not less than 150/(Nf) times a length of a screen of the display panel along a scanning direction.

The method of driving the self-luminous display apparatus further includes: (c) driving a third scanning line of the N scanning line; and (d) driving a fourth scanning line of the N scanning line immediately after the (c) driving. A distance between the third scanning line and the fourth scanning line is set to not less than 150/(Nf) times a length of the screen along the scanning direction. Also, the distance between the third scanning line and the fourth scanning line is set to be different from a distance between the first scanning line and the second scanning line. It is preferable that a direction from the third scanning line to the fourth scanning line is opposite to a direction from the first scanning line to the second scanning line.

In still another aspect of the present invention, a method of driving a self-luminous display apparatus is provided. The self-luminous display apparatus includes a display panel having N (N is a natural number) scanning lines. The N scanning lines including m (m is a natural number; m≧2) scanning line groups. Each of the m scanning line groups includes the k (k is a natural number) scanning lines. In this case, the method includes: (a) setting the m to satisfy an equation: 2≦m<Nf/150, when a frame frequency is f [Hz]; and (b) driving the j-th (j is a natural number; 1≦j≦k) scanning line of the i-th (i is a natural number; 1≦i≦m) scanning line group in the (i+m(j−1))-th turn in one frame.

As described above, the passive matrix type self-luminous display apparatus and the method of driving the same according to the present invention can reduce the flicker.

Moreover, the passive matrix type self-luminous display apparatus and the method of driving the same according to the present invention can suppress the electric power consumption.

Furthermore, the passive matrix type self-luminous display apparatus and the method of driving the same according to the present invention can suppress the deterioration of light emitting devices.

### BRIEF DESCRIPTION OF THE DRAWINGS

FIG. 1 is a schematic diagram showing a configuration of a self-luminous display apparatus according to the present invention;

FIG. 2 is a front view of the self-luminous display apparatus according to the present invention;

FIG. 3 is a side view of the self-luminous display apparatus according to the present invention;

FIG. 4 is a timing chart showing a method of driving the self-luminous display apparatus according to a first embodiment of the present invention;

FIG. 5 is a timing chart showing a method of driving the self-luminous display apparatus according to a second embodiment of the present invention;

FIG. 6 is a timing chart showing a method of driving the self-luminous display apparatus according to a third embodiment of the present invention;

FIG. 7 is a side view showing a configuration of a finder apparatus according to a fourth embodiment of the present invention;

FIG. 8A is a timing chart for showing an emitting operation with a certain rate of emission period; and

FIG. 8B is a timing chart for showing another emitting operation with another rate of emission period.

### DESCRIPTION OF THE PREFERRED EMBODIMENTS

A self-luminous display apparatus and a method of driving the same according to embodiments of the present invention will be described below with reference to the attached drawings. The self-luminous display apparatus includes a plasma display apparatus, an organic EL (Electro-Luminescence) display, a light emitting diode (LED) display apparatus and so on. In the present specification, a configuration and a driving method of an organic EL display apparatus will be described as an example.

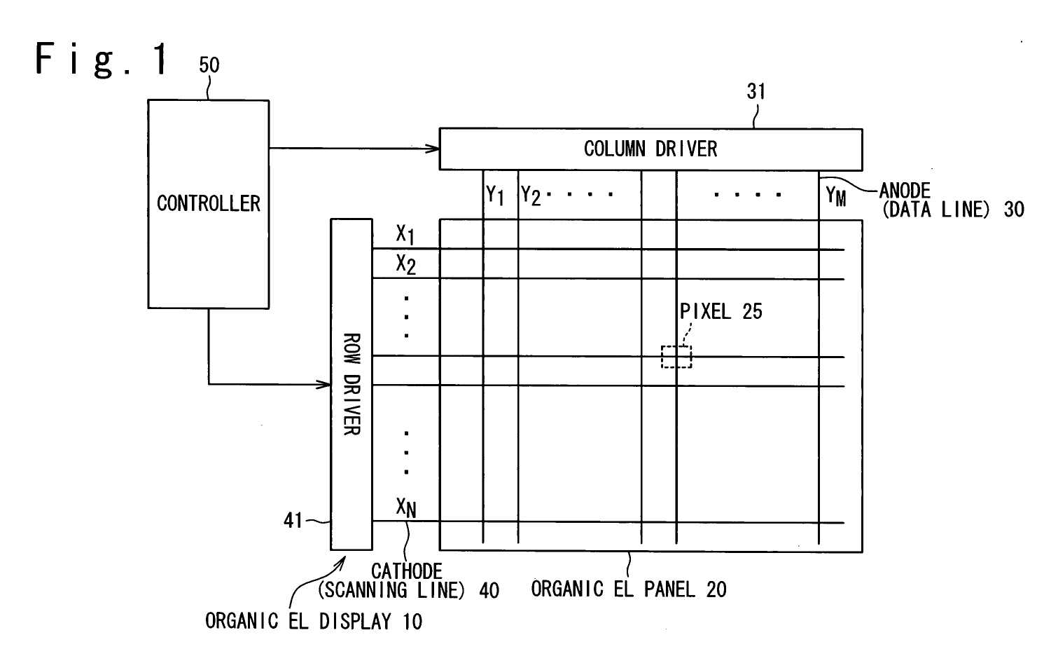

FIG. 1 is a schematic diagram showing a configuration of an organic EL display (apparatus) according to the present invention. In FIG. 1, the organic EL display 10 includes an organic EL panel 20 which has a plurality of pixels 25 which are arranged in a matrix form. The organic EL display 10 is of the “passive matrix type” and is driven by the passive matrix scheme. The organic EL display 10 has a plurality of anodes (data lines) 30 and a plurality of cathodes (scanning lines) 40.

As shown in FIG. 1, the number of the plurality of scanning lines 40 is N (N is a natural number). In other words, the plurality of scanning lines 40 consist of the first to the N-th scanning lines X₁ to X_{N}. The scanning lines X₁ to X_{N} are arranged apart from each other for a constant interval. Also, the number of the plurality of data lines 30 is M (M is a natural number). In other words, the plurality of data lines 30 consist of the first to the M-th data lines Y₁ to Y_{M}. The data lines Y₁ to Y_{M} are arranged apart from each other for a constant interval. The plurality of anodes 30 intersect with the plurality of cathodes 40 at a plurality of intersection points. One pixel (an organic EL device) 25 is provided for each of the plurality of intersection points. Thus, the plurality of pixels 25 are arranged in the matrix form.

The organic EL device 25 has the anode 30 which is a transparent electrode formed on a glass substrate, the cathode 40 made of a metal, and an organic layer sandwiched between the anode 30 and the cathode 40. Also, the organic layer includes an emission layer made of fluorescent organic compound, an electron transporting layer, and a hole transporting layer. When a predetermined voltage is applied between the anode 30 and the cathode 40, holes and electrons are injected into the emission layer from respective of the anode 30 and the cathode 40 through respective of the hole transporting layer and the electron transporting layer. The fluorescent organic compound is excited by the energy due to the recombination of the holes and the electrodes, which generates fluorescence. In other words, the organic EL device 25 emits light.

As shown in FIG. 1, the plurality of scanning lines 40 are connected to a row driver 41, and the plurality of data lines 30 are connected to a column driver 31. Also, the row driver 41 and the column driver 31 are connected to a controller 50. The controller drives the N scanning lines 40 by using an interlace scanning scheme. More specifically, the controller 50 controls the row driver 41 to select (drive) one scanning line 40. Also, the controller 50 controls the column driver 31 to apply to the plurality of data lines 30 voltages for displaying data associated with the selected one scanning line 40. As a result, the voltages are applied between the selected one scanning line (cathode) 40 and respective of the plurality of data lines (anode) 30, and the data is displayed at pixels 25 arranged in one row. The time for driving the one scanning line 40 is called a “horizontal period”. The above-mentioned operation is performed for all the scanning lines 40, namely, the above-mentioned operation is repeated for N times to display data associated with one image (still picture). The time required for performing the N operations is called a “frame”. Also, the number of frames per unit time is called a “frame frequency”. In the present specification, the frame frequency is given as f [Hz]. In this case, the horizontal period T [sec] is given by T=1/Nf.

In the passive matrix type organic EL display 10 mentioned above, a pixel 25 lights only when the pixel 25 is selected. That is to say, when a horizontal period for one scanning line 40 ends, the pixels 25 corresponding to the one scanning line 40 are turned off instantaneously. Thus, it is one emission line corresponding to one scanning line 40 which is displayed on the organic EL panel 20 at a certain instant. It is due to operations of the brain that humans recognize a display on a screen as a two-dimensional image. One emission line is treated as a residual image in the brain, and when the scanning is completed for one screen, a plurality of emission lines are reproduced as a two-dimensional image in the human's brain.

According to the method of driving the display apparatus of the present invention, the movement of the emission line is taken into consideration. A variety of parameters and symbols used for explaining the driving method in the present specification are defined as follows.

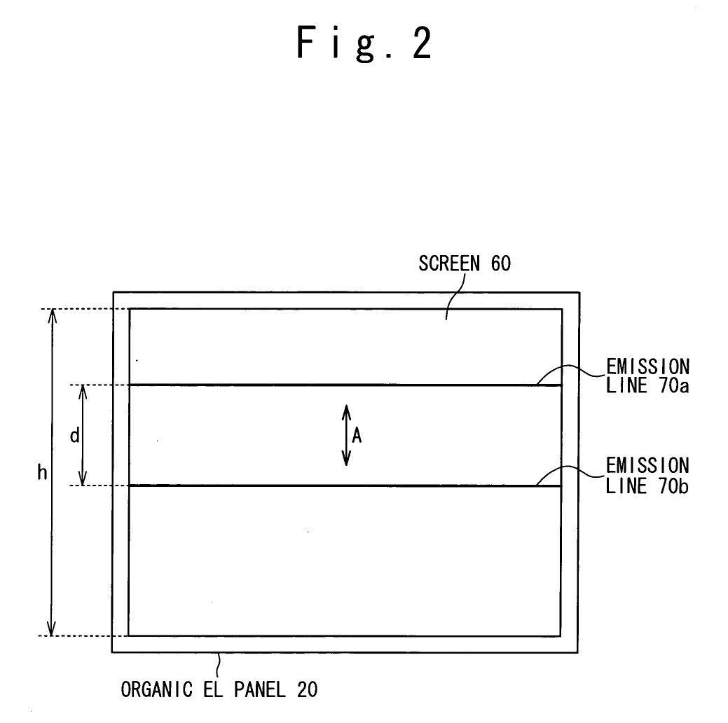

FIG. 2 is a front view of the organic EL panel 20 according to the present invention. As shown in FIG. 2, the organic EL panel 20 includes a screen 60. When a scanning line (referred to as a “first scanning line” hereinafter) of the N scanning lines X₁ to X_{N} is driven, an emission line 70a is displayed on the screen 60 in accordance with the first scanning line. Another scanning line (referred to as a “second scanning line” hereinafter) is driven immediately after the first scanning line. In other words, the second scanning line is driven next to the first scanning line. When the second scanning line is driven, an emission line 70b is displayed on the screen 60 in accordance with the second scanning line. A (vertical) distance between the emission line 70a and the emission line 70b is given as “d”. The distance “d” indicates a distance between the first scanning line driven in a horizontal period T and the second scanning line driven in the next horizontal period T. Also, a direction in which the scanning lines 40 are scanned is called as a “scanning direction” and is expressed as “A”, as shown in FIG. 2. A length of the screen 60 along the scanning direction A is expressed as “h”.

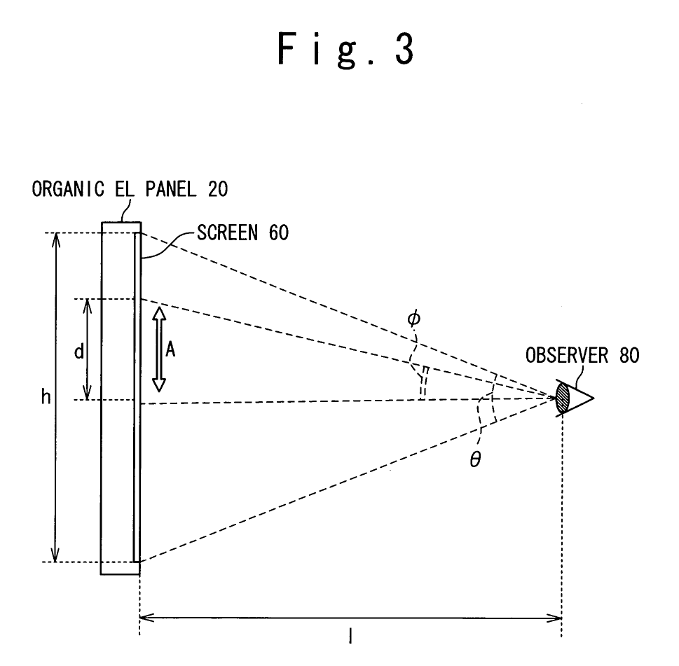

FIG. 3 is a side view of the organic EL panel 20 according to the present invention. In FIG. 3, the same symbols as in FIG. 2 denote the same parameters. As shown in FIG. 3, a distance between the screen 60 and an observer 80 who watches an image displayed on the organic EL panel 20 is expressed as “1”. Generally speaking, the distance “1” differs depending on the size of the screen 60. The distance 1 becomes longer as the size of the screen 60 becomes larger. The distance l becomes shorter as the size of the screen 60 becomes smaller.

Also, as shown in FIG. 3, a view angle with respect to the screen 60 along the scanning direction A for the observer 80 is expressed as θ. The view angle θ is approximately given by θ=tan⁻¹ (h/l). For example, in the case of a cell phone having 2 inch screen 60, the length h is about 40 mm. When the screen 60 is viewed at a distance of 40 cm, namely, when the distance 1 is 40 cm, the view angle θ is about 5.7°. Similarly, a view angle with respect to the distance “d” between the first scanning line (70a) and the second scanning line (70b) is expressed as φ. The view angle φ is approximately given by φ=θ×d/h.

### First Embodiment

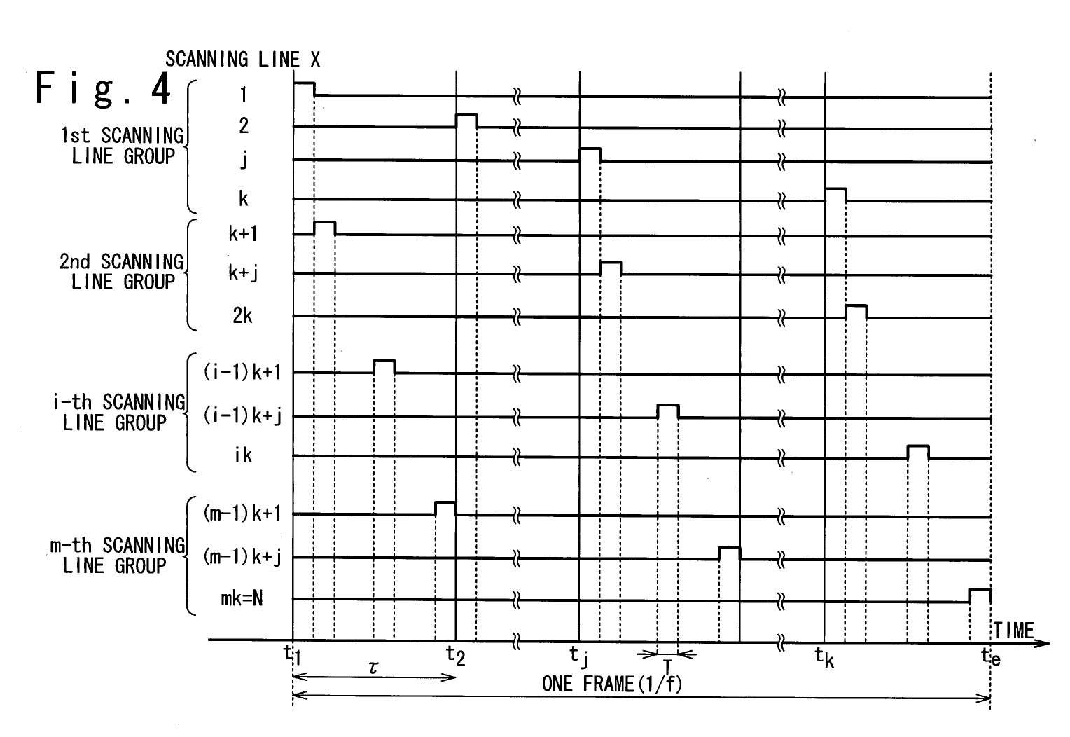

FIG. 4 is a timing chart showing a method of driving the organic EL display 10 according to a first embodiment of the present invention. In FIG. 4, an abscissa axis indicates the time, and an ordinate axis indicates numbers of the N scanning lines X₁ to X_{N}. As shown in FIG. 4 (and in FIG. 1), the N scanning lines X₁ to X_{N} are arranged from the top to the bottom in numerical order.

In the present embodiment, the N scanning lines X₁ to X_{N} are classified into a plurality of scanning line groups. More specifically, as shown in FIG. 4, the N scanning lines X₁ to X_{N} includes m (m is a natural number more than or equal to 2) scanning line groups; the first to the m-th scanning line groups. Each of the m scanning line groups has the same number of scanning lines X. That is, each scanning line group has k (k is a natural number) scanning lines X. For example, the first scanning line group has the scanning lines X₁ to Xₖ, and the second scanning line group has the scanning lines Xₖ₊₁ to X₂ₖ. The m-th scanning line group has the scanning lines X₍ₘ₋₁₎ₖ₊₁ to Xₘₖ. Thus, the number “N” of the plurality of scanning lines can be expressed as N=mk.

The method of driving the organic EL display 10 is as follows. First, at the time t1, one frame starts, and the first scanning line X₁ of the first scanning line group is driven. The driving period for one scanning line X is the horizontal period T, which is given by T=1/Nf. Next, the first scanning line Xₖ₊₁ of the second scanning line group is driven. After that, the first scanning lines X₍ᵢ₋₁₎ₖ₊₁ (i is a natural number; 1≦i≦m) of respective of the scanning line groups are similarly driven in order. At the end, the first scanning line X₍ₘ₋₁₎ₖ₊₁ of the m-th scanning line group is driven. As described above, in the period T from the time t1 to t2, the first scanning lines X₍ᵢ₋₁₎ₖ₊₁ of respective scanning line groups are driven in order.

Similarly, in the period T from the time t2, the second scanning lines X₍ᵢ₋₁₎ₖ₊₂ of respective scanning line groups are driven in order. Also, in the period τ from the time tⱼ (j is a natural number; 1≦j≦k), the j-th scanning lines X₍ᵢ₋₁₎ₖ₊ⱼ of respective scanning line groups are driven in order. Then, in the period T from the time from the time tₖ to tₑ, the k-th scanning lines Xⱼₖ or respective scanning line groups are driven in order. As a result, the scanning through the N scanning lines X₁ to X_{N} is completed once. The period (1/f) from the time t₁ to the time tₑ is the one frame.

During each period τ, m scanning lines X are driven. For example, the first scanning lines X₍ᵢ₋₁₎ₖ₊₁ of respective scanning line groups are driven in the first to the m-th turns. The second scanning lines X₍ᵢ₋₁₎ₖ₊₂ of respective scanning line groups are driven in the (m+1)-th to the 2m-th turns. The k-th scanning lines Xⱼₖ of respective scanning line groups are driven in the ((k−1)m+1)-th to the km-th turns.

To generalize the above-mentioned scanning order, the j-th (j is a natural number; 1≦j≦k) scanning line X of the i-th (i is a natural number; 1≦i≦m) scanning line group is driven in the (i+m(j−1))-th turn in one frame.

According to the driving method, for example, the distance between the scanning line X₁ and the following scanning line Xₖ₊₁ is h/m, where the “h” is the screen size and the “m” is the number of the scanning line groups. That is to say, the distance “d” between a scanning line X (a first scanning line) and a next-driven scanning line X (a second scanning line) is given as d=h/m (see FIG. 3). Also, the view angle φ with respect to the distance d is given as φ=θ×d/h, as mentioned above. In this case, the angular velocity ωb (the amount of movement per unit time) of the movement of the emission line 70 shown in FIG. 2 is given by the following equation:
ωb=φ/T=φNf=θdNf/h=θNf/m (1)

In the first embodiment of the present invention, the angular velocity ωb is set to be larger than an angular velocity ωs of the human's rapid eye movement (saccade). In other words, the angular velocity ωb is determined to satisfy the relationship: ωb>ωs. The resulting effects are as follows.

The organic EL device is a light emitting device having excellent response characteristics. Its speed of response to driving currents is high and, for example, a few nano-seconds. Therefore, in the passive matrix type organic EL display 10, afterglow is little or nothing as opposed to a general CRT (Cathode Ray Tube). When a horizontal period for one scanning line X ends, the pixels 25 corresponding to the one scanning line X are turned off instantaneously. Thus, it is one emission line 70 corresponding to the one scanning line X which is displayed on the organic EL panel-20 at a certain instant (see FIG. 2). The one emission line 70 is treated as a residual image in the brain. When the scanning is completed for one screen, a plurality of emission lines 70 are reproduced as a two-dimensional image in the human's brain.

When the human's brain recognizes an image, an average of instantaneous luminance of the emission lines 70 is recognized as the luminance of the image. Therefore, in order to acquire enough luminance for the human to recognize the image, it is necessary to set the instantaneous luminance higher. For example, in the case when the duty ratio is 1/200, it is necessary to set the instantaneous luminance at 20000 cd/m² for the human to recognize an image with the luminance of 100 cd/m². The instantaneous luminance is comparable to more than the luminance of a fluorescent light (5000 to 10000 cd/m²). If eyes moves completely synchronized with the scanning speed of emission lines, the stimulation is comparable to looking at a fluorescent light directly. In some cases, the stimulation becomes more intense.

When an emission line 70 shown in FIG. 2 moves in synchronization with the motion of the human's eyeball, the human's brain receives the above-mentioned strong stimulation due to the instantaneous luminance. This causes the flicker which human senses on the screen 60. According to the present invention, the angular velocity ωb of the movement of the emission line 70 is set to higher than the angular velocity of the motion of the human's eyeball. In particular, the angular velocity ωb is set to higher than the angular velocity ωs of the “saccade” which is a rapid eye movement. Practically, the number “m” of the scanning line groups may be set to an appropriate value. The above equation (1) and the above relationship (ωb>ωs) yield the following equation:
m<(θ/ωs)×Nf=Nf/α (2)

Here, the coefficient α is expressed as α=ωs/θ. In the above equation (2), the number N of the scanning lines and the frame frequency f are specific parameters of the organic EL display 10. According to the present embodiment, the number “m” of the scanning line groups is determined to satisfy the equation (2), and then the N scanning lines X₁ to X_{N} are successively driven in accordance with the above-explained rule. As a result, the angular velocity ωb of the movement of the emission line 70 becomes higher than the angular velocity ωs of the saccade. Thus, the flicker (flashing) peculiar to the passive matrix type self-luminous display apparatus can be reduced.

A decent value of the coefficient α in the above equation (2) can be determined as follows. The distance “l” between the screen 60 and the observer 80 varies depending on the size of the screen 60. For example, in the case of a cell phone having 2 inch screen 60, the length h is about 40 mm. When the screen 60 is viewed at a distance of 40 cm, namely, when the distance l is 40 cm, the view angle θ is about 5.7°. Also, it is known that the angular velocity ωs of the saccade is 300°/sec to 700°/sec. When the angular velocity ωs is 700°/sec (worst case), the coefficient α is calculated to be about 123 (α=ωs/θ). In order to support the worst case, the coefficient α is set to be higher than 123. For example, the coefficient α is set to “150”.

It goes without saying that the coefficient α also depends on the view angle θ. When the screen 60 of the above-mentioned cell phone is viewed at a distance of 20 cm, the flicker can be suppressed even if the coefficient α is set to 75 (=150/2). On the other hand, when the screen 60 of the above-mentioned cell phone is viewed at a distance of 80 cm, the flicker can be suppressed if the coefficient α is set to 300 (=150×2). By considering the effectiveness of the self-luminous display apparatus according to the present invention, which is a means for transmitting information, the coefficient α is set to 150, for example. When the apparatus can be used under a condition of larger view angle θ, the coefficient α may be set to a value smaller than 150. Since the view angle θ varies depending on the usage and the condition under which the display is used, the coefficient α is practically determined on the basis of the purpose, use environment, condition and so on.

When the coefficient α is set to 150, the above equation (2) is modified as follows:
m<Nf/150 (3)

According to the present embodiment, the number “m” of the scanning line groups is determined to satisfy the above equation (3). For example, in a case when an organic EL panel 20 having 100 scanning lines X is driven with a frame frequency of 50 Hz (N=100, f=50), the number m is set to lower than or equal to 33. When the number m of the scanning line groups is set to 25 (m=25), for example, the number k of the scanning lines included in each scanning line group is 4 (N=mk). When the number m of the scanning line groups is set to 10 (m=10), for example, the number k of the scanning lines included in each scanning line group is 10. Then, the N scanning lines X₁ to X_{N} are driven according to the above-mentioned rule. As a result, the angular velocity ωb of the movement of the emission line 70 becomes larger than the angular velocity ωs of the saccade. Thus, it is possible to reduce the flicker which is peculiar to the passive matrix type self-luminous display apparatus and is caused by the synchronization of the scanning of the emission lines and the movement of the line of sight.

As described above, according to the first embodiment of the present invention, the flicker caused by the synchronization of the scanning of the emission lines and the movement of the line of sight is reduced, and hence the image quality of the passive matrix type self-luminous display apparatus is improved. Moreover, the “interlace scanning” is performed to improve the speed of scanning the emission lines and to prevent the synchronization of the scanning of the emission lines and the movement of the line of sight. Thus, it is not necessary to increase the frame frequency for the purpose of reducing the flicker. In other words, the period (emission period) assigned for the driving of one scanning line is kept long. It is therefore possible to reduce the number of charging and discharging times for the parasitic capacitance included in the light emitting device (pixel), which can suppress and reduce the electric power consumption. Moreover, since it is not necessary to increase the frame frequency, one emission period (horizontal period T) for one light emitting device increases substantially. Therefore, the luminance of each emission required for achieving enough average luminance, which is inversely proportional to the emission period, can be reduced. It is not necessary to make one light emitting device to emit with excess luminance for the purpose of obtaining enough average luminance. Therefore, the deterioration of the light emitting device can be suppressed, and also, the organic EL device can operate in the high emission efficiency region, which can reduce the electric power consumption.

In the first embodiment explained above, the number of the scanning lines included in each scanning line group is plural (2, j, k) as shown in FIG. 4. As a result, there exists at least one scanning line X between a first scanning line and a second scanning line driven next to the first scanning line in one frame. In other words, when the second scanning line emits light immediately after the first scanning line emits light, it appears that at least one scanning line is skipped. Such an operation is called an “interlace (interlace scanning)”. The significance of the interlace scanning will be considered below. As mentioned above, one of objects of the present invention is to suppress and reduce the electric power consumption. For that purpose, it is effective not to increase the frame frequency and to set the frame frequency lower. Explanations will be given from that point of view.

When the number N of the scanning lines is constant, increase in the frame frequency is consistent with increase in the emission of the organic EL device per unit time. In this case, the charging and discharging of the parasitic capacitance accompanying the device increase, and hence the electric power consumption due to the charging and discharging increases. Also, the increase in the frame frequency is consistent with decrease in the emission period of each scanning line. The times necessary for the charging and the discharging are determined by voltages used for the charging and the discharging, and are not influenced by the duration time of one emission of one scanning line. Therefore, if the emission period for one scanning line is shortened, emission period rate is reduced substantially.

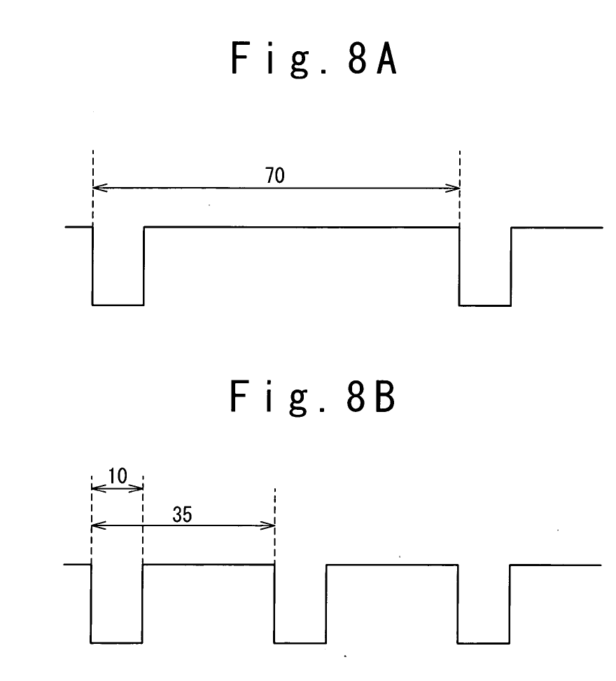

FIGS. 8A and 8B are timing charts for explaining change in the emission period rate when the frame frequency is changed. In FIGS. 8A and 8B, the ordinate axis indicates the driving voltage or the driving current, and the abscissa axis indicates the time. It should be noted that the scale of the ordinate axis is not necessary the same between FIGS. 8A and 8B. FIGS. 8A and 8B merely show the timings of the emissions. FIG. 8A shows the timing in a case when one drive period is 70 μs, and FIG. 8B shows the timing in a case when one drive period is 35 μs. That is to say, the frame frequency in the case of FIG. 8B is twice the frame frequency in the case of FIG. 8A. If the instantaneous luminance is the same between both cases, the average luminance which is visually recognized decreases as the emission period rate decreases.

As shown in FIGS. 8A and 8B, even when one drive period decreases from 70 μs to 35 μs, the charging and discharging period is almost constant (for example, 10 μs), because the charging and discharging period is basically determined by the parasitic capacitance. As a result, the emission period rate, which is a ratio of substantial emission period to one drive period, decreases from about 86% to about 71%. In order to secure the equivalent average luminance in both cases, it is necessary to increase the instantaneous luminance in the emission period by 20%. The increase in the instantaneous luminance causes the increase in the driving voltage and the enhancement of the power loss due to the charging and the discharging. In this example, the number of charging and discharging times becomes twice in the case of FIG. 8B as compared with the case of FIG. 8A. In addition to that, the power consumption in the charging and discharging increases due to the enhancement of the necessary instantaneous luminance (driving voltage). Furthermore, the increase in the instantaneous luminance causes the reduction of the life of the light emitting device. Thus, the increase in the frame frequency results in not only the increase in the electric power consumption but also the fall in long-term reliability.

Such a situation is caused when the frame frequency is merely increased without performing the interlace scanning. When the scanning speed of the emission line is increased without the interlace scanning, one drive period is reduced and thus the substantial emission period rate is decreases as explained above. Accordingly, the electric power consumption is increased, and the device life is decreases. On the contrary, when the interlace scanning is performed, not only the flicker can be suppressed and reduced but also the above-mentioned problems can be solved.

The interlace scanning is known in the field of the CRT (Cathode Ray Tube). However, the purpose of the interlace scanning in the CRT is to make it hard for the human to perceive the flicker due to the blinking of the emission surface by increasing the cycle of switching the surface. The “flicker” in this case is a phenomenon that the blinking of the planar emission is recognized due to the reduction of the blinking frequency and is felt unpleasant. The flicker in that case is a phenomenon that the drop of the luminance is recognized by the human.

While, the present invention deals with the “flicker” which is an excess stimulation caused by the synchronization of the movement of the emission line in the scanning direction and the movement of the line of sight. Although the condition that the flicker in a broad sense occurs is the same in both cases, the causes are different from each other. In order to clearly distinguish the “flicker in the present invention” from the “flicker in the case of CRT” caused by darkening, the “flicker in the present invention” may be referred to as the “flashing”. The stimulus due to the flashing is comparable to that when looking directly at electronic flash (stroboscope) or thunderbolt. As compared with the flicker caused by darkening, the flashing can be perceived for any length of time. For example, the darkening for a few ms in a cinema is hardly recognized, while the stroboscope of a few μs is absolutely perceived. One object of the present invention is to reduce the “flashing” phenomenon. As described above, the problem solved by the present invention is not the “flicker” caused by the reduction of blink frequency of the planar emission but the “flashing”.

Also, in the case of the interlaced scanning in the CRT, the increase in the number of the skipped scanning line causes skew of the scanning line. The interlace scanning in the case of a large number of skipped line results in the distortion of an image due to the skewed scanning line. For that reason, the interlace scanning in the CRT has been performed with setting the number of the skipped scanning line to one. In the display according to the present invention, the scanning line is not skewed and hence the above problem does not occur.

As explained above, it is more preferable that the number of the skipped lines is more than 2 as compared with the case when only one scanning line is skipped. Let us consider a case when the number N of the scanning lines is 240. When only one line is skipped (k=2), the number m of the scanning line groups is 120 as calculated from the relationship: N=mk. In this case, the frame frequency f should be set to satisfy a relationship: f>75, as is led from the above equation (3). When the number of the skipped lines is 2 (k=3), the number m is 80 and the frame frequency f is set to satisfy a relationship: f>50. As the number of the skipped lines increases, the effects of the present invention can be achieved by lower frame frequency.

The frame frequency is 60 Hz in a NTSC type TV, and 24 Hz in a theatrical film. Also, it is described as a result of the study of a common display that 75 Hz is the frequency with which the flicker is perceived. According to the present invention, the lower limit of the frame frequency may be set on the basis of these

### Second Embodiment

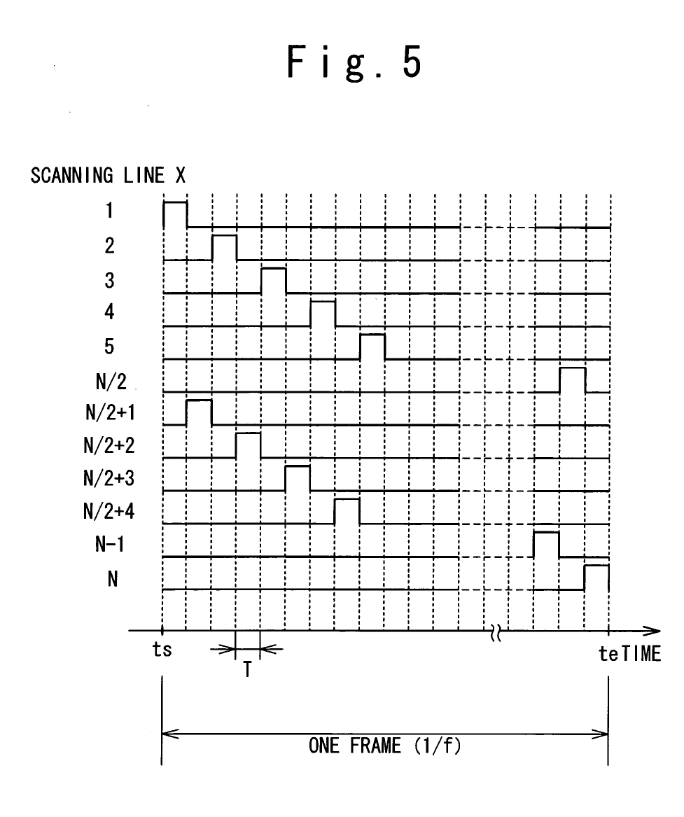

FIG. 5 is a timing chart showing a method of driving the organic EL display 10 according to a second embodiment of the present invention. In FIG. 5, an abscissa axis indicates the time, and an ordinate axis indicates numbers of the N scanning lines X₁ to X_{N}. A frame starts at the time tₛ and ends at the time tₑ.

According to the second embodiment of the present invention, the number m of the scanning line groups is set to 2. In this case, the first scanning line group includes N/2 scanning lines X₁ to X_{N/2}, and the second scanning line group includes N/2 scanning lines X_{(N/2)+1} to X_{N}. The N scanning lines X₁ to X_{N} are driven in a similar manner to the first embodiment. That is to say, the driving operation starts at the time tₛ, and then the N scanning lines X are driven in an order of X₁, X_{(N/2)+1}, X₂, X_{(N/2)+2}, X₃ . . . X_{N-1}, X_{N/2} and X_{N}.

For example, in the case of a cell phone having 2 inch screen 60, the length h is about 40 mm. When the screen 60 is viewed at a distance of 40 cm (l=40 cm), the view angle θ is about 5.7°. When the number N of the scanning lines is 100 and the frame frequency f is 50 Hz, the angular velocity ωb of the movement of the emission line 70 is calculated to be 14250°/sec based on the above equation (1). The angular velocity ωb is sufficiently larger than the angular velocity ωs of the saccade. Therefore, the flicker (flashing) caused by the synchronization of the emission line movement and the eyeball movement is prevented.

### Third Embodiment

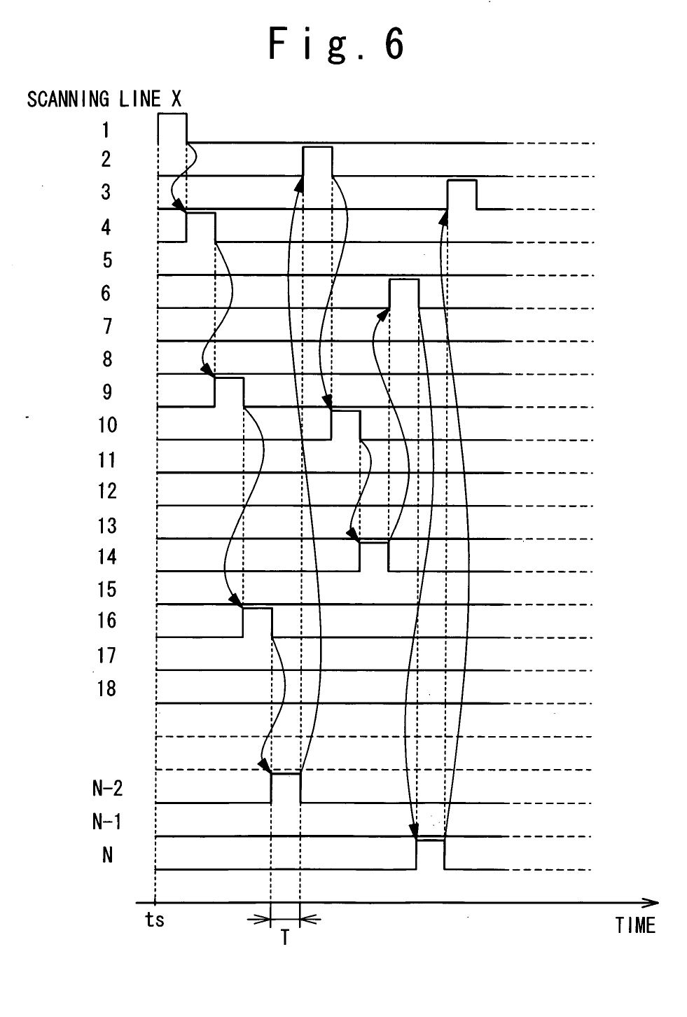

FIG. 6 is a timing chart showing a method of driving the organic EL display 10 according to a third embodiment of the present invention. In FIG. 6, an abscissa axis indicates the time, and an ordinate axis indicates numbers of the N scanning lines X₁ to X_{N}. A frame starts at the time tₛ. In FIG. 6, the scanning lines are driven in an order of X₁, X₄, X₉, X₁₆, X_{N-2}, X₂, X₁₀, X₁₄, X₆, X_{N}, X₃ . . . . That is to say, the distance between a scanning line X and the following scanning line X is not constant but varies. Also, the direction of movement of the emission line 70 is changed ad libitum.

The driving method according to the present embodiment is generalized as follows. A scanning line X (referred to as a first scanning line) is driven at a certain timing. Then, another scanning line X (referred to as a second scanning line) is driven immediately after the first scanning line. Also, a scanning line X different from the first scanning line (referred to as a third scanning line) is driven at another timing. Then, still another scanning line X (referred to as a fourth scanning line) is driven immediately after the third scanning line. In this case, a distance between the first scanning line and the second scanning line is set to be different from a distance between the third scanning line and the fourth scanning line. Also, a direction from the first scanning line to the second scanning line can be opposite to a direction from the third scanning line to the fourth scanning line.

Also in the present embodiment, the angular velocity ωb of the movement of the emission line 70 is set to be higher than the angular velocity ωs of the saccade. The above equation (1) and the above relationship (ωb>ωs) yield the following equation:
d>h×(ωs/θ)/(Nf)=h×α/(Nf) (4)

Here, the coefficient α is expressed as α=ωs/θ. In the above equation (4), the number N of the scanning lines and the frame frequency f are specific parameters of the organic EL display 10. For the reasons as mentioned in the first embodiment, the coefficient α is preferably set to 150, which gives the following equation:
d>h×150/(Nf) (5)

According to the present embodiment, the distance “d” is set to satisfy the above equation (4) or the above equation (5). In other words, the distance d between the first scanning line (the third scanning line) and the second scanning line (the fourth scanning line) is set to not less than 150/(Nf) times the length h of the screen 60 along the scanning direction A. When the difference in the number between the first scanning line and the second scanning line is n (n is a natural number), the distance d can be expressed as d=h×n/N. By using the relationship, the above equation (5) is modified into the following equation:
n>150/f (6)

The equation (5) and the equation (6) are equivalent. When the frame frequency f is, for example, 60 Hz, the number “n” is set to more than 2, as is obvious from the above equation (6). That is to say, after a scanning line (first scanning line) is driven, another scanning line (second scanning line) which is located apart from the first scanning line by more than 2 lines is driven. The order shown in FIG. 6 satisfies the above-described condition. As a result, the angular velocity ωb of the movement of the emission line 70 becomes larger than the angular velocity ωs of the saccade. Therefore, the flicker (flashing) peculiar to the passive matrix type self-luminous display apparatus is reduced. Moreover, the electric power consumption is suppressed and reduced, and the deterioration of the light emitting device is reduced.

When the distance l between the screen 60 and the observer 80 becomes long and the view angle θ with respect to the screen 60 becomes small, the emission line may possible move in synchronization with the motion of the eyeball due to the saccade. According to the present embodiment, the movement velocity of the emission line is not constant due to the non-uniform movement of the emission line. As a result, the possibility that the movement of the line of sight due to the saccade, which is a uniform motion, synchronizes with the movement of the emission line is reduced. Therefore, the possibility that the flashing is perceived is reduced.

The saccade motion of an eyeball is classified into ballistic motions which can not be controlled during the motion. That is to say, it is not possible to adjust the saccade motion by the sensory feedback. Thus, the saccade motion can be considered to be a uniform motion. According to the present embodiment, the angular velocity ωb of the movement of the emission line 70 varies. As a result, it is possible to reduce the probability that the eyeball consecutively moves in synchronization with the emission line 70. In other words, the probability that the brain consecutively receives stimulation due to the high-luminance emission is reduced, and hence the probability that the brain recognizes intense stimulation due to the integral effect is reduced. Thus, the flashing and the flicker recognized by human brain can be further reduced. Moreover, according to the present embodiment, the direction of the movement of the emission line 70 is appropriately changed, which can further reduce the flashing and the flicker.

### Fourth Embodiment

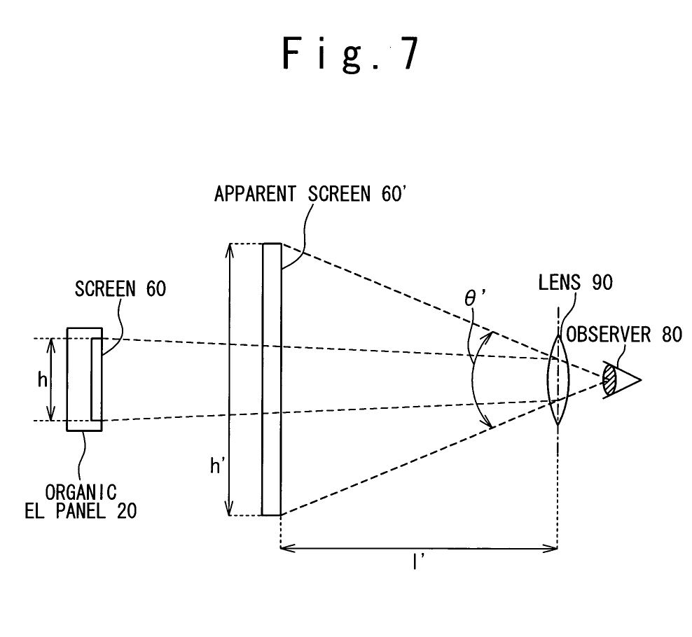

An observer 80 may look at the screen 60 of the organic EL panel 20 of the present invention through a lens. FIG. 7 is a schematic diagram for explaining such a condition. In FIG. 7, a lens 90 of x magnifications is provided between the screen 60 and the observer 80. In this case, the observer 80 recognizes an apparent screen 60′ which is the magnification of the screen 60.

When the length h′ of the apparent screen 60′ along the scanning direction A is given as h′=xh. Therefore, an apparent distance d′ between the above-mentioned first scanning line and the second scanning line is x times as long as the distance d on the screen 60. Thus, an apparent angular velocity ωb′ of the movement of the emission line 70 on the apparent screen 60′ is x times as large as the real angular velocity ωb on the screen 60. According to the present embodiment, the apparent angular velocity ωb′ is set to be higher than the angular velocity ωs of the saccade motion. In this case, the following equation similar to the above-described equation (4) can be obtained:
d′=xd>h×α/(Nf)
d>h×α/(xNf) (4)

Also, the following equation similar to the above-described equation (2) can be obtained:
m<xNf/α (2)′

As in the above-described embodiments, the coefficient α can be given by α=ωs/θ. According to the present embodiment, the distance “d” is set to satisfy the above equation (4)′, or the number “m” is determined to satisfy the above equation (2) For example, when the coefficient α is 150 and the magnification x of the lens 90 is 3, the distance d is set to satisfy the relationship: d>h×50/(Nf). The scanning order and the scanning direction of the N scanning lines are the same as in the first to the third embodiments described above.

The configuration according to the fourth embodiment of the present invention can be applied to, for example, a compact display apparatus such as a view finder of a camera. The compact display apparatus includes the lens 90 of x magnifications and the organic EL panel 20 according to the present embodiment. A user observes the screen 60 through the lens 90. In this case, the apparent angular velocity ωb′ of the emission line 70 is larger than the angular velocity ωs of the saccade motion. Thus, the same effects as in the above-described embodiments can be attained.

In the above embodiments of the present invention, a display panel is exemplified by the organic EL panel 20. It goes without saying that the driving method according to the present invention can be applied to a plasma display panel and a passive matrix type LED display panel.

It will be obvious to one skilled in the art that the present invention may be practiced in other embodiments that depart from the above-described specific details. The scope of the present invention, therefore, should be determined by the following claims.

1. A self-luminous display apparatus, which is of a passive matrix type, comprising:
a display panel having N (N is a natural number) scanning lines; and
a controller for driving said N scanning lines sequentially,
wherein said N scanning lines includes:
a first scanning line; and
a second scanning line driven next to said first scanning line,
wherein, when a frame frequency is f [Hz], said controller sets a distance between said first scanning line and said second scanning line to not less than 150/(Nf) times a length of a screen of said display panel along a scanning direction.

2. The self-luminous display apparatus according to claim 1,
wherein said N scanning lines further includes:
a third scanning line; and
a fourth scanning line driven next to said third scanning line,
wherein said controller sets a distance between said third scanning line and said fourth scanning line to not less than 150/(Nf) times a length of said screen along said scanning direction, and
said distance between said first scanning line and said second scanning line is different from said distance between said third scanning line and said fourth scanning line.

3. The self-luminous display apparatus according to claim 2,
a direction from said first scanning line to said second scanning line is opposite to a direction from said third scanning line to said fourth scanning line.

4. The self-luminous display apparatus according to claim 1,
wherein said controller drives said N scanning lines by using an interlace scanning scheme.

5. A self-luminous display apparatus, which is of a passive matrix type, comprising:
a display panel having N (N is a natural number) scanning lines; and
a controller for driving said N scanning lines sequentially,
wherein said N scanning lines includes:
a first scanning line;
a second scanning line driven next to said first scanning line;
a third scanning line; and
a fourth scanning line driven next to said third scanning line,
said controller sets a distance between said first scanning line and said second scanning line different from a distance between said third scanning line and said fourth scanning line.

6. The self-luminous display apparatus according to claim 5,
a direction from said first scanning line to said second scanning line is opposite to a direction from said third scanning line to said fourth scanning line.

7. The self-luminous display apparatus according to claim 1,
wherein said display panel is an organic EL panel.

8. The self-luminous display apparatus according to claim 1,
wherein said display panel is a plasma display panel.

9. The self-luminous display apparatus according to claim 1,
wherein said display panel is a passive matrix type light emitting diode display panel.

10. A display apparatus comprising:
a self-luminous display apparatus which is of a passive matrix type; and
a lens of x magnifications provided for said self-luminous display apparatus,
wherein said self-luminous display includes a display panel having N (N is a natural number) scanning lines,
said N scanning lines includes:
a first scanning line; and
a second scanning line driven next to said first scanning line,
wherein, when a frame frequency is f [Hz], a distance between said first scanning line and said second scanning line is set to not less than 150/(xNf) times a length of a screen of said display panel along a scanning direction.

11. The display apparatus according to claim 10,
wherein said N scanning lines are driven by using an interlace scanning scheme.
